(19) United States
(12) Patent Application Publication
(10) Pub. No.: US 2017/0323025 A1
(43) Pub. Date: Nov. 9, 2017

(54) BROWSER ACCELERATION METHOD AND BROWSER DEVICE HAVING ACCELERATOR

(71) Applicant: BEIJING QIHOO TECHNOLOGY COMPANY LIMITED, Beijing (CN)

(72) Inventors: Xinchao TIAN, Beijing (CN); Xiaobing YANG, Beijing (CN); Peng XIONG, Beijing (CN); Qingguang GAO, Beijing (CN)

(21) Appl. No.: 15/526,260

(22) PCT Filed: Oct. 22, 2015
(86) PCT No.: PCT/CN2015/092585

§ 371 Date: May 11, 2017

(30) Foreign Application Priority Data
Nov. 11, 2014 (CN) 201410642315.6

(51) Int. Cl. G06F 17/30; G06F 12/0817; G06F 9/54; G06F 17/22; G06F 3/0482

(52) U.S. Cl. CPC G06F 17/30902; G06F 9/547; G06F 17/30132; G06F 17/30864; G06F 12/0817; G06F 3/0482; G06F 17/2235

(57) ABSTRACT

Disclosed are a browser acceleration method and a browser device having an accelerator with a user interaction interface including an interactive element for achieving a function of push-to-accelerate and at least one of a memory optimization option, a cache cleanup option and an opening acceleration option, the method comprising: detecting a selection state of the options and receiving a triggering operation on the interactive element; and in accordance with the selection state and the triggering operation, implementing functions of: invoking a memory management API of an operating system to release excessive memory occupied by the browser; and/or invoking a file operation API of an operating system to clean up cache files in a cache directory; and/or determining a preload link in a current page and preloading a webpage corresponding to the preload link.

### CROSS-REFERENCE TO RELATED APPLICATIONS

This application is the national stage of International Application No. PCT/CN2015/092585 filed Oct. 22, 2015, which claims the benefit of Chinese Patent Application No. CN 201410642315.6, filed Nov. 11, 2014, the entirety of which are incorporated herein by reference.

### FIELD OF TECHNOLOGY

The present invention relates to the field of Internet technologies, and in particular, to a browser acceleration method and browser device having an accelerator.

### BACKGROUND

A web browser is an application that can display files within a web server or file system and allow users to interact therewith. It is used to display texts, images, and other information obtained on the World Wide Web or the Local Area Network according to the user's request. These texts or images can be hyperlinks in connection with other web address or a variety of information that can be quickly and easily browsed by the user.

The browser is the most commonly used client program. As more webpages are opened by a user in the browser, webpage processes running in the background become increased such that more browser caches are occupied. Excessive memory occupied by the browser could not be released timely. When the browser's memory is used excessively or up to a maximum memory capacity, the browser may become slow or paused.

FIG. 1 is a schematic diagram showing a browser acceleration interface in the prior art. As shown in FIG. 1, at present, a commonly used method of accelerating the browser is as follows: by clicking an Internet option in the browser, a dialog box as shown in FIG. 1 could pop up, and a user selects the “Delete Browsing History on Exit” option in the pop-up dialog box and then clicks the “Delete” button on the lower right side to clean up the browsing history. However, above-mentioned cleaning method has a very limited cleaning capacity, only involving temporary files, cookies, form information and the like, and thus has an inferior acceleration effect on the browser.

Alternatively, the system memory cleanup or the cookie cleanup by external software of the browser can reduce the excessive memory occupied by the browser to a certain extent. However, in such a manner, it is very inconvenient for the user to necessarily operate more than one external tool. Further, these external tools can not accurately obtain demands of the browser kernel and the processes on the memory occupation, resulting in a very limited optimization effect.

### SUMMARY

In view of the above problems, the present invention has been made in order to provide a browser acceleration method and a browser device having an accelerator which can overcome above problems or at least partially solve or mitigate above problems.

In accordance with one aspect, there is provided a browser acceleration method, the browser having an accelerator with a user interaction interface including an interactive element for achieving a function of push-to-accelerate and at least one of a memory optimization option, a cache cleanup option and an opening acceleration option, the method comprising:
detecting a selection state of the options and receiving a triggering operation on the interactive element; and
in accordance with the selection state and the triggering operation, implementing functions of: invoking a memory management API of an operating system to release excessive memory occupied by the browser; and/or invoking a file operation API of an operating system to clean up cache files in a cache directory; and/or determining a preload link in a current page and preloading a webpage corresponding to the preload link.

In accordance with another aspect, there is provided a browser device having an accelerator with a user interaction interface having an interactive element for implementing a push-to-accelerate function and at least one of a memory optimization option, a cache cleanup option and an opening acceleration option, the browser device comprising:
a detection module, configured to detect a selection state of the options and receive a triggering operation on the interactive element;
a memory management module, configured to invoke a memory management API of an operating system to release excessive memory occupied by the browser in accordance with the selection state and the triggering operation; and/or
a cache module, configured to invoke a file operation API of an operating system to clean up cache files in a cache directory; and/or
a preload module, configured to determine a preload link in a current page and preload a webpage corresponding to the preload link according to the selection state and the triggering operation.

In accordance with still another aspect, there is provided a computer program, including computer readable codes, wherein any one of above browser acceleration methods is executed by a computing device when the computer readable codes are carried out on the computing device.

In accordance with still yet another aspect, there is provided a computer readable medium, in which the above-described computer program is stored.

Beneficial Effects of the Present Invention are:

According to the browser acceleration method and the browser device having an accelerator according to the present invention, the accelerator is built in the browser interface to provide multiple acceleration options, including memory cleanup, cache cleanup and preload link, integrating the running, reading/writing and loading acceleration of the browser. It is very convenient for the user to clear related contents by selecting the acceleration options anytime without external tools.

Described above is merely an overview of the inventive scheme. In order to more apparently understand the technical means of the present invention to implement in accordance with the contents of specification, and to more readily understand above and other objectives, features and advantages of the present invention, particular embodiments of the present invention are provided hereinafter.

### BRIEF DESCRIPTION OF THE DRAWINGS

Various other advantages and benefits will become apparent to those having ordinary skill in the art upon reading the following detailed description of the preferred embodiments. The accompanying figures are provided for the purpose of illustrating preferred embodiments only and should not be construed as limiting the present invention. Throughout the figures, the same reference numerals are used to designate the same elements. In the drawings:

FIG. 1 is a schematic diagram showing a browser acceleration interface in the prior art;

FIG. 2a is a schematic diagram showing an interface of an accelerator contained in a browser of the present invention;

FIG. 2b shows a flow diagram of a browser acceleration method according to one embodiment of the present invention;

FIG. 2c shows a schematic diagram of a user interaction interface after browser acceleration according to one embodiment of the present invention;

FIG. 3 shows a flow diagram of an acceleration method implemented by optimizing background webpage memory by a browser according to one embodiment of the present invention;

FIG. 4 shows a flow diagram of an acceleration method implemented by releasing decoded image memory by a browser according to one embodiment of the present invention;

FIG. 5 shows a flow diagram of a browser acceleration method according to one embodiment of the present invention;

FIG. 6 shows a flow diagram of a method of preloading a webpage by a browser according to one embodiment of the present invention;

FIG. 7 shows a flow diagram of a method of preloading a webpage by a browser according to another embodiment of the present invention;

FIG. 8 shows a block diagram of a browser device having an accelerator according to one embodiment of the present invention;

FIG. 9 shows a block diagram of a browser device having an accelerator according to another embodiment of the present invention;

FIG. 10 shows a block diagram of a computing device for executing the browser acceleration method according to the present invention; and

FIG. 11 shows a memory cell for keeping or carrying program codes implementing the browser acceleration method according to the present invention.

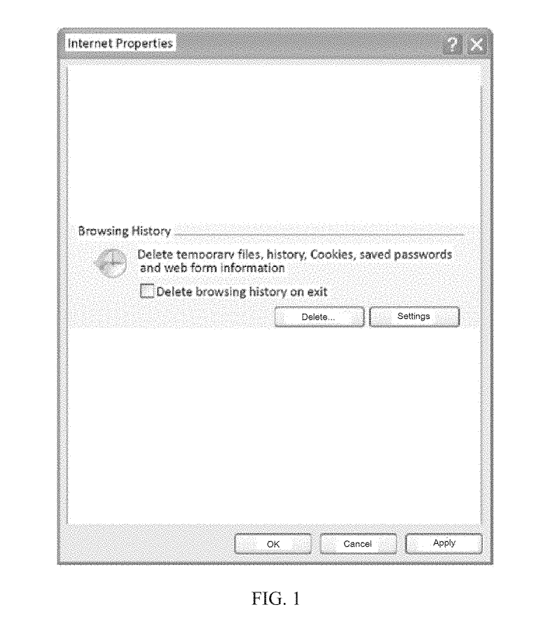

### DESCRIPTION OF THE EMBODIMENTS

Exemplary embodiments of the present invention will be described in detail with reference to the accompanying figures hereinafter. Although the exemplary embodiments of the present invention have been illustrated in the accompanying figures, it should be understood that the present invention may be embodied in many different forms and are not intended to be limited to the embodiments set forth herein. Rather, these embodiments are provided so as to thoroughly and completely understand the present invention and fully convey the scope of the present invention to those skilled in the art.

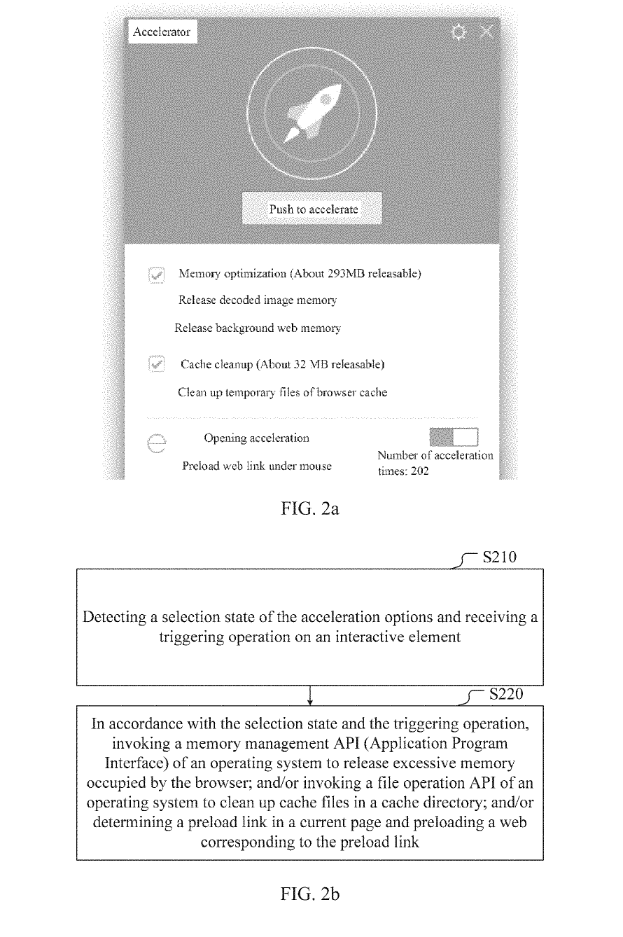

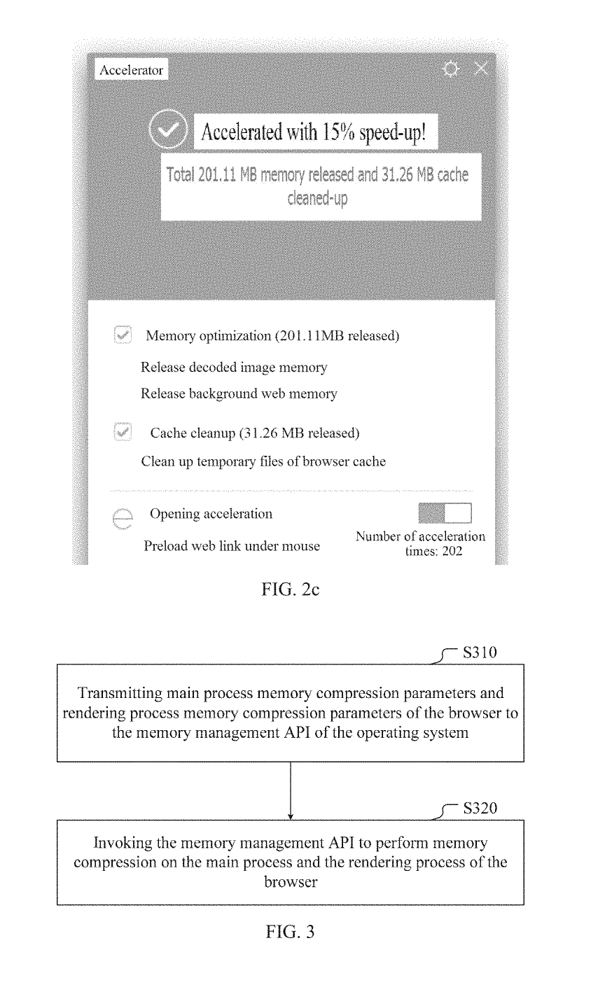

FIG. 2a is a schematic diagram showing an interface of an accelerator included in a browser of the present invention. As shown in FIG. 2a, a user interaction interface can be display after the accelerator is activated. The user interaction interface includes options of memory optimization, cache cleanup and opening acceleration, as well as a push-to-accelerate trigger button. Multiple options may receive user's selection states in arbitrary combination. In the detection of triggering the push-to-accelerate button, the accelerator may perform related functions according to the user's selection states of multiple buttons. Specifically, if the memory optimization option is selected, performable functions may include the release of the background webpage memory and the decoded image memory; if the cache cleanup option is selected, the temporary files of the browser cache may be cleared; if the opening acceleration option is selected, the browser may preload a webpage link.

The accelerator is hidden in an inactive state. Specifically, an accelerator activation button can be set in the browser's status bar, menu bar or sidebar, etc., and can be activated via a click to display the user interaction interface as described above.

FIG. 2b shows a flow diagram of a browser acceleration method according to one embodiment of the present invention. As shown in FIG. 2b, this method comprises at least the following steps:

Step S210, detecting a selection state of the acceleration options and receiving a triggering operation on an interactive element.

In the accelerator as shown in FIG. 2a, the memory optimization option, the cache cleanup option and the opening acceleration option or a combination of the above options can be selected. The triggering operation can be received by detecting the push-to-accelerate button in a graphical user interface or by operating a given shortcut.

The acceleration of the browser in the present invention may include an acceleration of operating speed and startup speed of the browser, which could be achieved primarily by optimizing the memory and clearing the cache, and a speed-up of opening the webpage, which is achieved by preloading the webpage link.

Step S220, in accordance with the selection state and the triggering operation, invoking a memory management API (Application Program Interface) of an operating system to release excessive memory occupied by the browser; and/or invoking a file operation API of an operating system to clean up cache files in a cache directory; and/or determining a preload link in a current page and preloading a webpage corresponding to the preload link.

If the memory optimization option is selected, a function of releasing the excessive memory occupied by the browser may be performed. The excessive memory occupied by the browser may include the memory taken up by all the processes of the browser. The different existing browsers have a variety of process modes. For example, in a Chrome browser, the browser processes may include a browser main process for handling a user interface and a browser user interface (UI) framework and managing other processes; and a rendering process for dealing with the rendering of independent tag page, in addition to a plug-in process and an extension process. The memory actually occupied by the processes of the browser is higher than the memory required to implement the functions, thereby causing the excessive memory. For example, after a tag page is rendered, the memory that is occupied during the rendering of the page is not released in time and becomes redundant memory.

In addition, the excessive memory occupied by the browser may further include the memory occupied by the decoded images. Webpage files on the request of the browser often contains images that are formed as binary data by image compression processing such as BMP, EPS, GIF, JPG and PNG compression. The browser needs to extract encoded images in the file to generate images before rendering the page. After decoding, the memory occupied in the process of decoding is no longer needed. However, the memory occupied by the browser decoded images could not be timely released. As images are decoded, the occupied memory will increase accordingly to the extent of affecting browser speed. Upon the triggering of the acceleration button, the browser may locate the memory occupied by the decoded images and invoke the memory management API of the system to release this part of the memory.

If the cache cleanup option is selected, the browser may perform a function of cleaning up the cache files. The browser cache files are related files, such as requested page files, pictures, scripts and the like, that are stored in a local disk by the browser for saving bandwidth and could be directly extracted from the cache when the user requests the same again. This involves a disk I/O (Input/Output) operation. When the cache files are excessively large, they could impact the startup speed and the operating speed of the browser. The browser cache files are usually stored in a default or specified directory. When the cache is to be cleared, the browser may transmit the directory of the cache files as a parameter to the system file operation API and invoke the file operation API to delete the cache files in the specified directory.

If the opening acceleration option is selected, the browser may determine the preload link to preload in the current page. The preload link is a link that the user may possibly access in the current page. Preloading is the process of sending a webpage file request to the preload link before user's actual access, buffering the webpage files on request in the local, and directly obtaining the local webpage files when the user clicks to access so as to reduce page's opening time and user's waiting time.

The preload link can be determined in a number of ways. For example, user's behaviors can be predicted to determine the preload link based on the user's browsing history or interest model. Or a hot link with high total clicks and a link with long total browsing time in the current page can be used as the preload link. Or a link that the user has an intention to open can be determined as the preload link. For example, the preload link can be determined according to a location where the user is currently browsing.

When multiple above-mentioned acceleration options are selected at the same time, the browser may simultaneously or sequentially perform above-described functions.

FIG. 2c shows a schematic diagram of a user interaction interface after browser acceleration. After the accelerator's acceleration is complete, as shown in FIG. 2c, an acceleration result can be displayed, including the size of actually released memory and the size of cleaned-up cache files. The acceleration effect can be calculated based on memory release and cache cleanup before and after acceleration. For example, as shown in FIG. 2c, the browser speed is increased by 15% after acceleration.

In the present invention, the activation and display of accelerator interface, the detection of selection state, and the transfer and invocation of the parameters in connection with the operating system APIs are completed by the main process of the browser and implemented in program design of main program of the browser. Thus it is not necessary to rely on external tools or browser plug-ins, avoiding complex interface processing between programs. In the present invention, with the combination of various accelerating ways in the browser, the user can easily activate the accelerator when browsing the webs and it is very convenient to realize the acceleration of the cache, the memory and the preload by selecting the acceleration options. Further, in this way, the optimization is made only to the memory occupied by the browser without any impact on other programs of the system.

Specific implementations of the memory optimization and the opening acceleration will be described below by way of various embodiments.

FIG. 3 shows a flow diagram of an acceleration method implemented by optimizing background webpage memory by a browser according to one embodiment of the present invention. The browser may optimize memory of the main process and the rendering process by means of the method. As shown in FIG. 3, the method may comprise at least following steps:

Step S310, transmitting main process memory compression parameters and rendering process memory compression parameters of the browser to the memory management API of the operating system.

A minimum main process memory value occupied by the browser main process and a minimum rendering process memory value occupied by the rendering process of the browser are transmitted to the memory management API, respectively, as the parameters. Or a default parameter value is transmitted to the memory management API. Above mentioned minimum memory value can be designated by the browser according to operating conditions.

Step S320, invoking the memory management API to perform memory compression on the main process and the rendering process of the browser.

If, at Step S310, the minimum memory value as the parameter is transmitted to the memory management API, then the step may invoke the memory management API to compress the memory values occupied by the main process and the rendering process to the minimum memory value.

If, at Step S310, the default parameter is transmitted to the API, then after the step is invoked, the memory management API of the system may perform automatic compression on the memory of the main process and the rendering process of the browser according to the current system state.

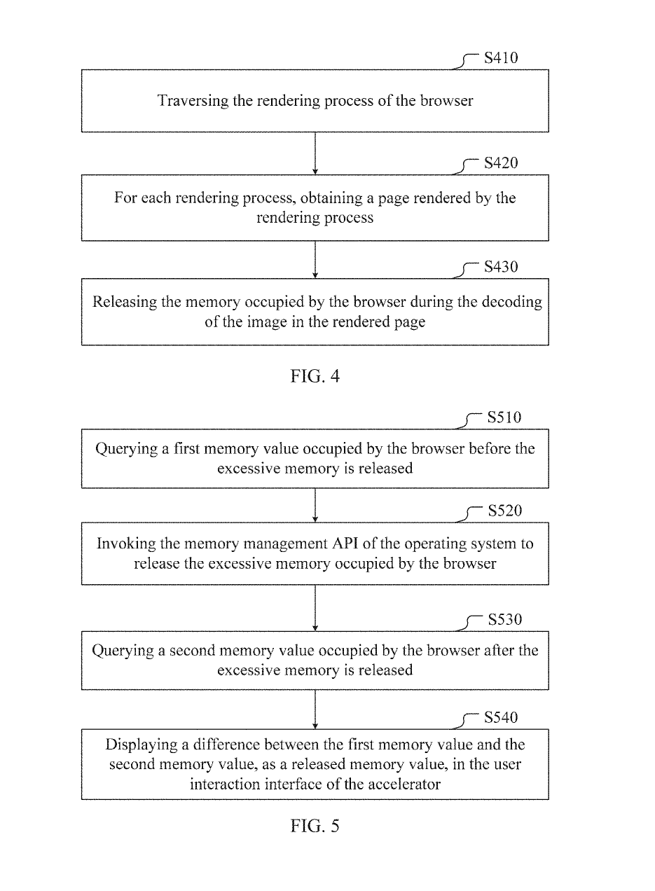

FIG. 4 shows a flow diagram of an acceleration method implemented by releasing decoded image memory by a browser according to one embodiment of the present invention. As shown in FIG. 4, the method may comprise at least following steps:

Step S410, traversing the rendering process of the browser.

For images of different encoding formats, such as BMP, EPS, GIF, JPG and PNG, the browser may employ a related decoding method to decode the images and then render through the rendering process. The releasing of the memory of the decoded image is performed after the respective image is rendered. In this embodiment of the present invention, the decoded images can be located by traversing the rendering process.

Step S420, for each rendering process, obtaining a page rendered by the rendering process.

Each rendering process corresponds to one or more opened pages. Since the images in the rendered pages are certainly decoded, in this embodiment the memory occupied by the decoded images can be regarded as an object to be released.

Step S430, releasing the memory occupied by the browser during the decoding of the image in the rendered page.

Similar to the previous embodiment, the memory is released by invoking the memory management API of the system.

FIG. 5 shows a flow diagram of a browser acceleration method according to one embodiment of the present invention. As shown in FIG. 5, the method comprises at least following steps:

Step S510, querying a first memory value occupied by the browser before the excessive memory is released.

By invoking an API interface of the system in relation to memory query to query memory occupation status of each process, the memory value occupied by each process may be added as the first memory value.

Step S520, invoking the memory management API of the operating system to release the excessive memory occupied by the browser.

Specifically, reference may be made to Step S310, the description of which will be omitted herein.

Step S530, querying a second memory value occupied by the browser after the excessive memory is released.

After the memory management API is invoked, the query and the calculation processes at Step S510 are repeated to obtain the second memory value.

Step S540, displaying a difference between the first memory value and the second memory value, as a released memory value, in the user interaction interface of the accelerator.

As shown in FIG. 2c, a memory value of 201.11 MB is released after acceleration.

Similarly, a size of cleaned-up cache may also be exhibited, and then a degree of speed increment can be calculated according to the sizes of the released memory and cache and the system status, allowing users to keep abreast of the acceleration effect.

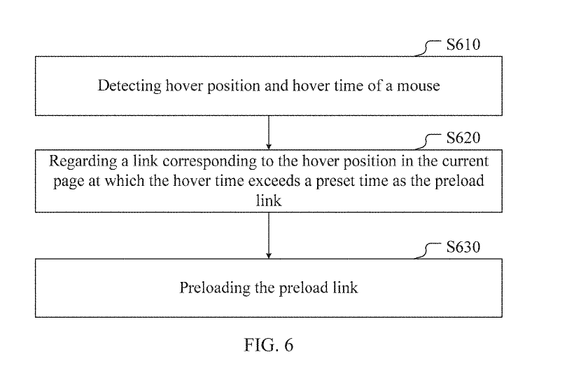

FIG. 6 shows a flow diagram of a method of preloading a webpage by a browser according to one embodiment of the present invention. This embodiment can be used to improve a page opening speed of the browser. As shown in FIG. 6, the method comprises at least following steps:

Step S610, detecting hover position and hover time of a mouse.

In the preloading method of this embodiment, the preload link can be determined by judging user's intention. The hover position and the hover time of the mouse can reflect the user's intention.

Step S620, regarding a link corresponding to the hover position in the current page at which the hover time exceeds a preset time as the preload link.

When the mouse hovers over a link for a certain time, the user is considered as having an intention to open the link. For example, the hover time can be set to 100 ms.

Step S630, preloading the preload link.

A webpage file request is sent to the preload link and the file cache returned from the server is stored in local, saving the user's waiting time after the page is opened.

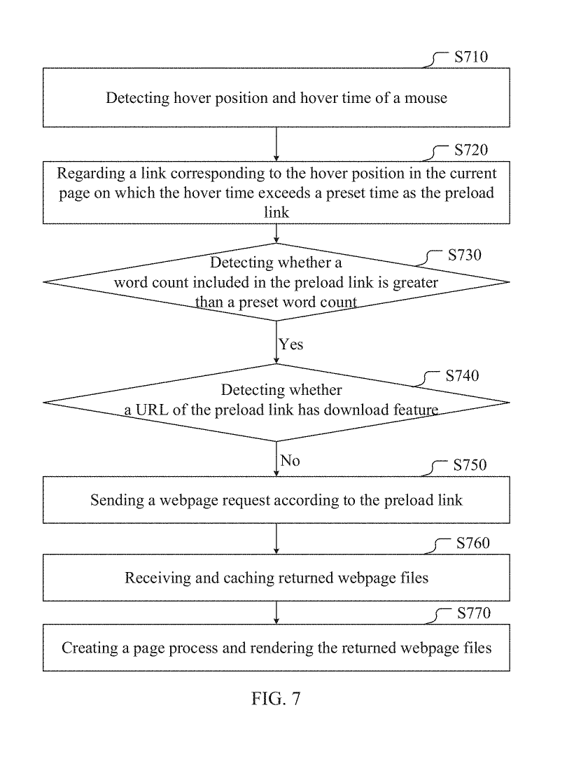

FIG. 7 shows a flow diagram of a method of preloading a webpage by a browser according to another embodiment of the present invention. As shown in FIG. 7, the method comprises at least following steps:

Step S710, detecting hover position and hover time of a mouse.

Step S720, regarding a link corresponding to the hover position in the current page on which the hover time exceeds a preset time as the preload link.

Step S730, detecting whether a word count included in the preload link is greater than a preset word count, wherein if it is larger than the preset number of words, then go to Step S740.

Before the user's actual access, the preload process may obtain suppositional webpage file contents that the user may possibly visit from the server, thereby reducing the waiting time of the user after clicking to open the link. This is mainly used to solve prolonged opening time of the page due to client or server-side bandwidth limit.

The preloading method has an effectiveness problem. If the user does not visit the preloaded page or the preloading process has less effect on the opening speed of page, then the resource will be wasted and the efficiency lowered.

In general, a webpage title of which has a word count less than a preset word count may contain relatively simple webpage content. Often such a webpage is easily loaded. Or a webpage with low bandwidth requirement for the user and with stable web server performance can be promptly opened, for examples, well-known web portals such as Baidu, Sina and Phoenix in navigation page or links of sub-sites pointing for example to news, sports and finance in Sina home page.

As an example, the preset word count can be set to 8. If a title of a link has a word count less than 8, then the link will be excluded from the preload link to improve the preload efficiency.

Step S740, identifying whether or not a Uniform Resource Locator (URL) of the preload link has a download feature, wherein if it does not have the download feature, then go to Step S750.

For example, a URL with a download feature may be such a URL ending in MP3 or rar. This type of URL generally does not correspond to the webpage files such as Hypertext Markup Language (html) but other application files, and thus there is no need to preload.

It is to be noted that neither there is sequential restriction nor it is necessary to execute at the same time between Step S730 and Step S740. Further, Step S730 and Step S740 are provided exemplarily and other processes also can be used to filter the preload link. For example, only the links with Hyper Text Transfer Protocol (http) and Hyper Text Transfer Protocol (https) are preloaded, while other types of links, such as File Transfer Protocol (ftp), and links in a search result page are excluded.

Step S750, sending a webpage request according to the preload link.

Step S760, receiving and caching returned webpage files.

Step S770, rendering the returned webpage files.

In the method of this embodiment, the webpage files in the preloaded cache are also rendered. The rendering is executed in the background. Specifically, the rendering can be made using an idle rendering process or a new page process without displaying a tab page of the new page process. After the user clicks the preload link, a tab page can be created to display the rendered page.

In the preloading method according to this embodiment, the ineffective preload link can be excluded by filtering the word count and the type of the links, whereby improving the effectiveness of preloading and advantageously speeding up the browser.

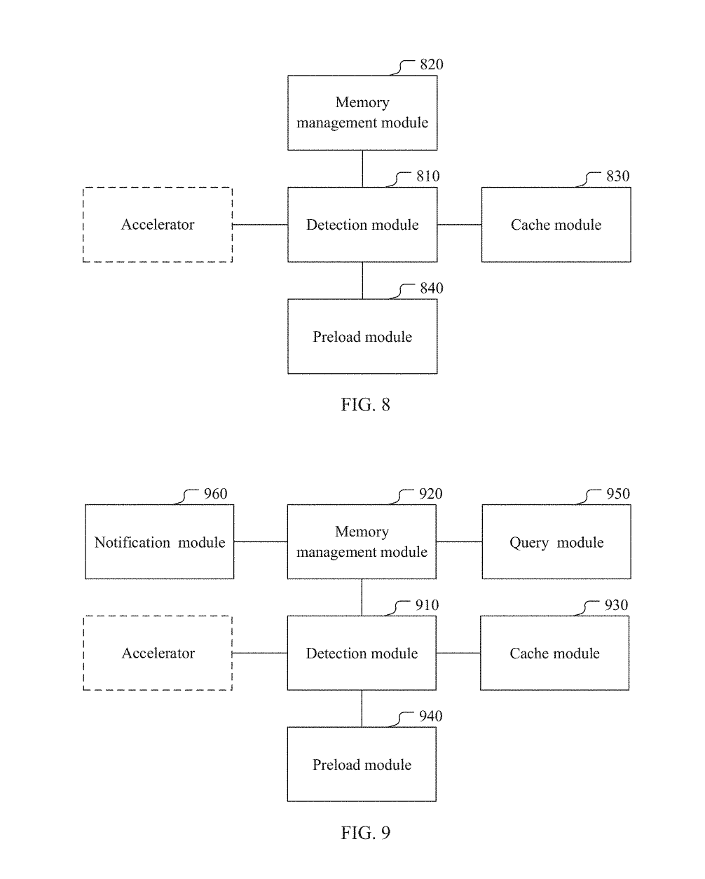

FIG. 8 shows a browser device having an accelerator according to one embodiment of the present invention, wherein a user interaction interface of the accelerator is as shown in FIG. 2a comprising an interactive element for implementing a push-to-accelerate function and at least one of a memory optimization option, a cache cleanup option and an opening acceleration option. The browser device comprises at least:
a detection module 810, configured to detect a selection state of the options and receive a triggering operation on the interactive element.

In particular, the detection module 810 can receive the triggering operation by detecting the push-to-accelerate button in a graphical user interface or by operating a given shortcut.

The browser device further comprises at least one of modules:
a memory management module 820, configured to invoke a memory management API of an operating system to release excessive memory occupied by the browser in accordance with the selection state and the triggering operation; and/or
a cache module 830, configured to invoke a file operation API of an operating system to clean up cache files in a cache directory; and/or
a preload module 840, configured to determine a preload link in a current page and preload a webpage corresponding to the preload link according to the selection state and the triggering operation.

Herein, memory optimization objects of the memory management module 820 may comprise excessive memory occupied by the browser, including memory taken up by all the processes of the browser and memory taken up by a decoded image.

The memory management module 820 may achieve above functions when the memory optimization option is selected, the cache module 830 may achieve above functions when the cache cleanup option is selected, and the preload module 840 may achieve above functions when the opening acceleration option is selected.

FIG. 9 shows a browser device having an accelerator according to another embodiment of the present invention, wherein a user interaction interface of the accelerator is as shown in FIG. 2a, comprising an interactive element for implementing a push-to-accelerate function and at least one of a memory optimization option, a cache cleanup option and an opening acceleration option. The browser device having the accelerator comprises at least:
a detection module 910, configured to detect a selection state of the options and receive a triggering operation on an interactive element. The browser device having the accelerator further comprises at least one of modules:
a memory management module 920, configured to invoke a memory management API of an operating system to release excessive memory occupied by the browser in accordance with the selection state and the triggering operation.

Optionally, the memory management module 920 is particularly configured to invoke the memory management API of the operating system to perform memory compression on the main process and the rendering process of the browser.

In particular, the memory management module 920 transmits a minimum main process memory value occupied by the browser main process and a minimum rendering process memory value occupied by the rendering process to the memory management API, respectively, as the parameters, and compresses actual memory values occupied by the main process and the rendering process of the browser into the minimum main process memory value and the minimum rendering process memory value, respectively, by invoking the memory management API; or
the memory management module 920 transmits a default parameter value to the memory management API, and automatically compresses the main process and the rendering process of the browser according to the system state by invoking the memory management API.

Optionally, the memory management module 920 is further configured to invoke the memory management API of the operating system to release the memory occupied by the browser during the decoding of an image.

In particular, the memory management module 920 traverses the rendering process of the browser, obtains a page rendered by the rendering process for each rendering process, and releases the memory occupied by the browser during the decoding of the image in the rendered page.
a cache module 930, configured to invoke a file operation API of an operating system to clean up cache files in a cache directory according to the selection state and the triggering operation.

Optionally, the cache module 930 transmits the assigned cache directory of the browser to the file operation API, and deletes the cache files in the cache directory of the browser by invoking the file operation API.
a preload module 940, configured to determine a preload link in a current page and preload a webpage corresponding to the preload link according to the selection state and the triggering operation.

Optionally, the preload module 940 detects hover position and hover time of a mouse, and regards a link corresponding to the hover position in the current page at which the hover time exceeds a preset time as the preload link.

Optionally, the preload module 940 detects a word count included in a link title of the preload link, and preloads a webpage corresponding to a link that the word count included in the title is greater than a preset word count while excludes a link that the word count included in the title is shorter than the preset word count. For example, the preset word count can be set to 8.

Optionally, the preload module 940 also identifies a URL of the preload link; and excludes a link that the URL has a download feature from the preload link.

Optionally, the preload module 940 sends a webpage request according to the preload link, receives and caches returned webpage files, and renders the cached webpage files using the rendering process.

Optionally, the browser device having the accelerator comprises at least:
a query module 950, configured to query a first memory value occupied by the browser before the excessive memory is released, and query a second memory value occupied by the browser after the excessive memory is released.
a notification module 960, configured to display a difference between the first memory value and the second memory value, as a released memory value, in the user interaction interface of the accelerator.

In the browser device having the accelerator according to above embodiments of the present invention, the activation and display of accelerator interface, the detection of selection state, and the transfer and invocation of the parameters in connection with the operating system APIs are completed by the main process of the browser and implemented in program design of main program of the browser. Thus it is not necessary to rely on external tools or browser plug-ins, avoiding complex interface processing between programs. In the present invention, with the combination of various accelerating ways in the browser, the user can easily activate the accelerator when browsing the webpages and it is very convenient to realize the acceleration of the cache, the memory and the preload by selecting the acceleration options. Further, in this way, the optimization is made only to the memory occupied by the browser without any impact on other programs of the system.

The algorithms and displays provided herein are not inherently relevant to any particular computer, virtual system, or other device. Various general-purpose systems can also be used with teaching based on this. According to the above description, the structure required to construct such a system is obvious. In addition, the present invention is not directed to any particular programming language. It should be understood that the present invention may be embodied in various programming languages and that the foregoing description of a particular language is intended to disclose the best mode of the present invention.

A number of specific details are set forth in the specification provided herein. However, it will be appreciated that embodiments of the present invention may be practiced without these specific details. In some instances, well-known methods, structures, and techniques have not been shown in detail so as not to obscure the understanding of this specification.

Similarly, it is to be understood that in order to simplify the present invention and to assist in understanding one or more of the various inventive aspects, each of the features of the present invention is sometimes grouped together into a single embodiment in the above description of exemplary embodiments of the present invention An embodiment, a diagram, or a description thereof. However, the disclosed method should not be construed as reflecting the intent that the claimed invention is more characteristic than the features clearly set forth in each claim. More specifically, as reflected in the following claims, the inventive aspect is less than all of the features of the previously disclosed single embodiment. Accordingly, the claims that follow the specific embodiments are expressly incorporated into this particular embodiment, each of which is a separate embodiment of the invention.

It will be understood by those skilled in the art that the modules in the apparatus in the embodiments may be adaptively changed and placed in one or more devices different from the embodiment. The modules or units or components in the embodiments may be combined into one module or unit or component, and in addition they may be divided into a plurality of submodules or subunits or subcomponents. All of the features disclosed in this specification (including the accompanying claims, abstract and drawings) and any of the methods disclosed herein, or any of the methods disclosed herein, may be employed in any combination, except that such features and/or at least some of the processes or units are mutually exclusive All the processes or units of the device are combined. Unless otherwise expressly stated, each feature disclosed in this specification (including the accompanying claims, abstract and drawings) may be replaced by alternative features that provide the same, equivalent or similar purpose.

In addition, it will be understood by those skilled in the art that although some of the embodiments described herein include certain features included in other embodiments and not other features, the combination of features of different embodiments means that within the scope of the invention and to form different embodiments. For example, in any of the following claims, any one of the claimed embodiments may be used in any combination.

Each of components according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the components in the browser device having an accelerator according to the embodiments of the present invention. The present invention may further be implemented as device program (for example, computer program and computer program product) for executing some or all of the methods as described herein. Such program for implementing the present invention may be stored in the computer readable medium, or have a form of one or more signals. Such a signal may be downloaded from the Internet websites, or be provided in carrier, or be provided in other manners.

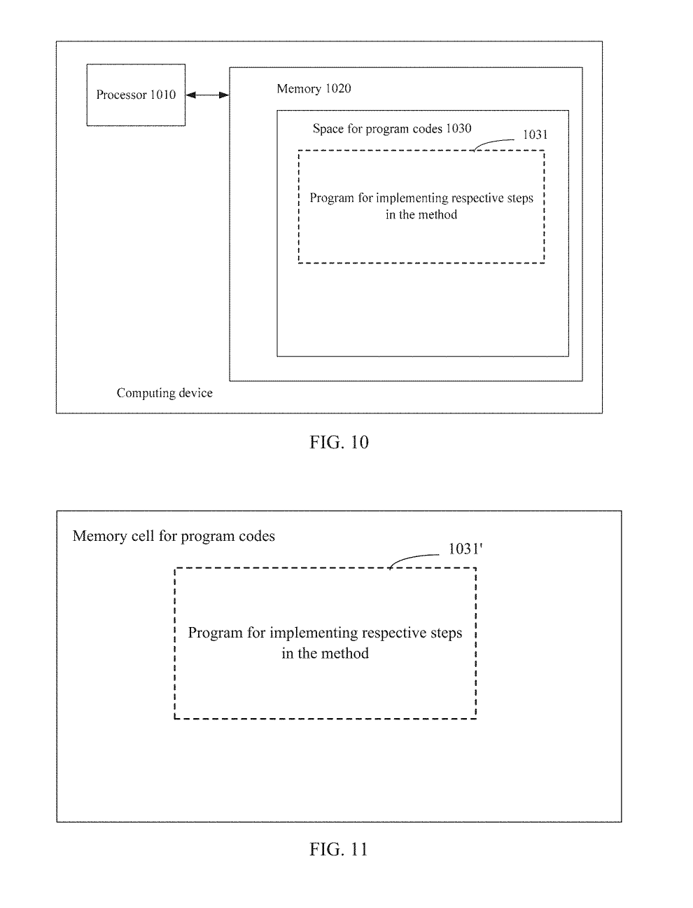

For example, FIG. 10 illustrates the computing device which may implement the browser acceleration method according to this present invention. Traditionally, the communication device includes a processor 1010 and a computer program product or a computer readable medium in form of a memory 1020. The memory 1020 could be electronic memories such as flash memory, EEPROM (Electrically Erasable Programmable Read-Only Memory), EPROM, hard disk or ROM. The memory 1020 has a memory space 1030 for executing program codes 1031 of any steps in the above methods. For example, the memory space 1030 for program codes may include respective program codes 1031 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 11. The memory cells may be provided with memory sections, memory spaces, etc., similar to the memory 1020 of the communication device as shown in FIG. 11. The program codes may be compressed for example in an appropriate form. Usually, the memory cell includes a program 1031′ for executing the method steps according to the present invention, which could be codes readable for example by processors 1010. When these codes are operated on the communication device, the communication device may execute respective steps in the method as described above.

Reference herein to “one embodiment”, “an embodiment” or “one or more embodiments” means that a particular feature, structure, or characteristic described in connection with embodiments are included in at least one embodiment of the present invention. Also, it should be noted that the wordings herein “in one embodiment” are not necessarily all referring to the same embodiment.

It should be noted that the above-described embodiments are intended to illustrate but not to limit the present invention, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The present invention may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

In addition, it should also be noted that the language used in this specification is chosen primarily for the purpose of readability and teaching, and is not intended to be used for the purpose of explaining or defining the subject matter of the present invention. Accordingly, many modifications and variations will be apparent to those of ordinary skill in the art without departing from the scope and spirit of the appended claims. The scope of the invention is intended to be illustrative and not restrictive, and the scope of the invention is defined by the appended claims.

1. A browser acceleration method, the browser having an accelerator with a user interaction interface including an interactive element for achieving a function of push-to-accelerate and at least one of a memory optimization option, a cache cleanup option and an opening acceleration option, the method comprising:
detecting a selection state of the options and receiving a triggering operation on the interactive element; and
in accordance with the selection state and the triggering operation, implementing functions of: invoking a memory management API of an operating system to release excessive memory occupied by the browser; invoking a file operation API of an operating system to clean up cache files in a cache directory; or determining a preload link in a current page and preloading a webpage corresponding to the preload link.

2. The method according to claim 1, wherein the invoking a memory management API of an operating system to release excessive memory occupied by the browser comprises:
transmitting a minimum main process memory value occupied by the main process of the browser and a minimum rendering process memory value occupied by the rendering process of the browser to the memory management API, respectively, as the parameters, and compressing actual memory values occupied by the main process and the rendering process of the browser into the minimum main process memory value and the minimum rendering process memory value, respectively, by invoking the memory management API; or
transmitting a default parameter value to the memory management API, and performing automatic memory compression on the main process and the rendering process of the browser according to the system state by invoking the memory management API.

3.-4. (canceled)

5. The method according to claim 1, wherein the invoking a memory management API of an operating system to release excessive memory occupied by the browser comprises:
traversing the rendering process of the browser;
for each rendering process, obtaining a page rendered by the rendering process; and
releasing the memory occupied by the browser during the decoding of the image in the rendered page.

6. (canceled)

7. The method according to claim 1, wherein the invoking a file operation API of an operating system to clean up cache files in a cache directory further comprises:
transmitting an assigned cache directory of the browser to the file operation API, and deleting the cache files in the cache directory of the browser by invoking the file operation API.

8. The method according to claim 1, wherein the determining a preload link in a current page further comprises:
detecting hover position and hover time of a mouse; and
regarding a link corresponding to the hover position in the current page at which the hover time exceeds a preset time as the preload link.

9. The method according to claim 1, wherein the preloading a webpage corresponding to the preload link in a current page further comprises:
detecting a word count included in a link title of the preload link; and
preloading a webpage corresponding to a link that the word count included in the title is greater than a preset word count.

10. The method according to claim 1, wherein the preloading a webpage corresponding to the preload link further comprises:
identifying a URL of the preload link; and
excluding a link that the URL has a download feature from the preload link.

11. The method according to claim 1, wherein the preloading a webpage corresponding to the preload link further comprises:
sending a webpage request according to the preload link;
receiving and caching returned webpage files; and
rendering the cached webpage files using the rendering process.

12. The method according to claim 1, wherein before the invoking a memory management API of an operating system to release excessive memory occupied by the browser, the method further comprises: querying a first memory value occupied by the browser before the excessive memory is released; and
after the invoking a memory management API of an operating system to release excessive memory occupied by the browser, the method further comprises:
querying a second memory value occupied by the browser after the excessive memory is released; and
displaying a difference between the first memory value and the second memory value, as a released memory value, in the user interaction interface of the accelerator.

13. A browser device having an accelerator with a user interaction interface including an interactive element for achieving a function of push-to-accelerate and at least one of a memory optimization option, a cache cleanup option and an opening acceleration option, the browser device comprising:
a memory having instructions stored thereon;
a processor configured to execute the instructions to perform operations comprising:
detecting a selection state of the options and receiving a triggering operation on the interactive element; and
in accordance with the selection state and the triggering operation, implementing functions of:
invoking a memory management API of an operating system to release excessive memory occupied by the browser in accordance with the selection state and the triggering operation; or
invoking a file operation API of an operating system to clean up cache files in a cache directory; or
determining a preload link in a current page and preloading a webpage corresponding to the preload link.

14. The device according to claim 13, wherein the operation of invoking a memory management API of an operating system to release excessive memory occupied by the browser comprises:
transmitting a minimum main process memory value occupied by the main process of the browser and a minimum rendering process memory value occupied by the rendering process of the browser to the memory management API, respectively, as the parameters, and compressing actual memory values occupied by the main process and the rendering process of the browser into the minimum main process memory value and the minimum rendering process memory value, respectively, by invoking the memory management API; or
transmitting a default parameter value to the memory management API, and performing automatic memory compression on the main process and the rendering process of the browser according to the system state by invoking the memory management API.

15.-16. (canceled)

17. The device according to claim 13, wherein the operation of invoking a memory management API of an operating system to release excessive memory occupied by the browser comprises:
traversing the rendering process of the browser;
for each rendering process, obtaining a age rendered by the rendering process; and
releasing the memory occupied by the browser during the decoding of the image in the rendered page.

18. (canceled)

19. The device according to claim 13, wherein the operation of invoking a file operation API of an operating system to clean up cache files in a cache directory further comprises: transmitting an assigned cache directory of the browser to the file operation API, and deleting the cache files in the cache directory of the browser by invoking the file operation API.

20. The device according to claim 13, wherein the operation of determining a preload link in a current page further comprises:
detecting hover position and hover time of a mouse; and
regarding a link corresponding to the hover position in the current page at which the hover time exceeds a preset time as the preload link.

21. The device according to claim 13, wherein the operation of preloading a webpage corresponding to the preload link in a current page further comprises:
detecting a word count included in a link title of the preload link; and
preloading a webpage corresponding to a link that the word count included in the title is greater than a preset word count.

22. The device according to claim 13, wherein the operation of preloading a webpage corresponding to the preload link further comprises:
identifying a URL of the preload link; and
excluding a link that the URL has a download feature from the preload link.

23. The device according to claim 13, wherein the operation of preloading a webpage corresponding to the preload link further comprises:
sending a webpage request according to the preload link;
receiving and caching returned webpage files; and
rendering the cached webpage files using the rendering process.

24. The device according to claim 13, wherein the operations further comprises:
querying a first memory value occupied by the browser before the excessive memory is released and querying a second memory value occupied by the browser after the excessive memory is released; and
displaying a difference between the first memory value and the second memory value, as a released memory value, in the user interaction interface of the accelerator.

25. (canceled)

26. A non-transitory computer readable medium having computer programs stored thereon that, when executed by one or more processors of a browser device, cause the browser device to perform operations for browser acceleration, the browser having an accelerator with a user interaction interface including an interactive element for achieving a function of push-to-accelerate and at least one of a memory optimization option, a cache cleanup option and an opening acceleration option, the operations comprising:
detecting a selection state of the options and receiving a triggering operation on the interactive element; and
in accordance with the selection state and the triggering operation, implementing functions of: invoking a memory management API of an operating system to release excessive memory occupied by the browser; or invoking a file operation API of an operating system to clean up cache files in a cache directory; or determining a preload link in a current page and preloading a webpage corresponding to the preload link.
